(19) United States
(12) Patent Application Publication
(10) Pub. No.: US 2010/0214636 A1
(43) Pub. Date: Aug. 26, 2010

(54) Method of Manufacturing Oscillator Device, and Optical Deflector and Image Forming Apparatus

(75) Inventors: Suguru Miyagawa, Tokyo (JP); Kazunari Fujii, Kawasaki-shi (JP); Takahisa Kato, Tokyo (JP); Kazutoshi Torashima, Yokohama-shi (JP); Takahiro Akiyama, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/680,813

(22) PCT Filed: Dec. 10, 2008
(86) PCT No.: PCT/JP2008/072905

§ 371 Date: Mar. 30, 2010

(30) Foreign Application Priority Data
Dec. 10, 2007 (JP) 2007-318027
May 28, 2008 (JP) 2008-139629

(51) Int. Cl. G02B 26/08; B23P 11/00; B23K 26/38

(52) U.S. Cl. 359/197.1; 29/428; 219/121.72

(57) ABSTRACT

A method of manufacturing an oscillator device having a fixed member and an oscillation plate supported by the fixed member through a supporting member for oscillation around a torsion axis, the oscillation plate being driven at a resonance frequency around the torsion axis, includes a frequency regulating step based on an extension member for adjustment of a mass of the oscillation plate, for forming the extension member on the oscillation plate and for adjusting the mass of the oscillation plate by cutting a portion of the extension member with the irradiation of a laser beam, an oscillator assembling step for fixing the fixed member to a fixed base, and a driving member assembling step for fixing a driving member for driving the oscillation plate to the fixed base, wherein at least the driving member assembling step is carried out after the frequency regulating step based on the extension member is performed.

### TECHNICAL FIELD

This invention relates to a method of manufacturing an oscillator device, and to an optical deflector and an image forming apparatus. The present invention concerns a technique which realizes, for example, an optical deflector having an oscillator device that can be preferably used in a projection display device for projecting an image by scanning deflection of light, or an image forming apparatus such as a laser beam printer, a digital copying machine or the like having an electrophotographic process.

### BACKGROUND ART

Micromechanical members to be produced from a silicon substrate by a semiconductor process can have a processing precision of micrometer order, and thus various micro-function devices have been realized based on these. For example, various proposals have been made with regard to actuators (oscillator devices) using a resonance phenomenon of a movable element (oscillation plate) which can be formed based on such technique and configured to torsionally oscillate.

Particularly, as compared with conventional optical-scanning optical systems using a rotary polygonal mirror such as a polygon mirror, those optical deflectors in which a reflection surface (optical deflecting element) is formed on such a movable element (oscillation plate) and the optical scan is carried out based on the resonance phenomenon of the movable element (oscillation plate) have the following advantages: that is, the size of the optical deflector can be made small; the optical deflector made of silicon monocrystal through the semiconductor process has theoretically no metal fatigue and has a good durability; the power consumption is quite small; and so on.

Particularly, where the deflector is driven around the frequency of the natural oscillation mode of the torsional oscillation of the movable element (oscillation plate), the power consumption can be much lowered.

However, on the other hand, in the optical deflectors using such resonance phenomenon, due to dimensional errors caused during the manufacturing process, dispersion of the resonance frequency (frequency of the natural oscillation mode) may occur between individual actuators.

Such dispersion of the resonance frequency between individual actuators is undesirable and, therefore, the resonance frequency needs to be adjusted.

Furthermore, when the actuator is used, if there is a reference frequency which is the operation (driving) frequency set at a predetermined value, inconsistency may occur between the frequency of the natural oscillation mode and the reference frequency.

Thus, in the optical deflectors comprised of such actuator, the aforementioned inconsistency between the frequency of the natural oscillation mode and the reference frequency will cause dispersion of the deflection angle of the movable element.

In the electrophotographic process using an optical deflector such as in a laser beam printer, the image is formed by scanning a photosensitive member with a laser beam. In order to stabilize the aspect ratio of the image and to reduce deterioration of the picture quality, the dispersion of the deflection angle of the movable element of the optical deflector should be suppressed in accordance with the rotational speed of the photosensitive member and, to this end, the resonance frequency of the optical deflector should be adjusted to a predetermined value.

Conventionally, there is a proposal of a planar type galvano mirror as an actuator which enables the adjustment of the resonance frequency as mentioned above (Japanese Laid-Open Patent Application No. 2002-40355).

In this technique, as shown in FIG. 20, a planar type galvano mirror having a movable plate with a reflection surface and a coil is used. The movable plate is resiliently supported for oscillation around a torsion axis, and mass loading members 3001 and 3002 are formed at opposite ends of the movable plate. By irradiating the mass loading members 3001 and 3002 of this galvano mirror with a laser beam, the mass is removed to adjust the inertia moment, thereby to set the frequency at a predetermined value.

This mirror is comprised of a moving coil type driving mechanism wherein permanent magnets 3004 and 3005 are provided on both sides of the movable plate 3003 and, when an electric voltage is applied to a planar coil formed on the movable plate 3003, rotation around torsion bars 3006 and 3007 is caused.

### DISCLOSURE OF THE INVENTION

In an actuator based on the resonance phenomenon as described above, for lower power consumption, it is desired that the movable element (oscillation plate) is driven around the frequency of the natural oscillation mode and, therefore, adjustment of the resonance frequency is required.

Furthermore, in an image forming apparatus using an optical deflector comprised of such actuator, in order to stabilize the aspect ratio of the image and to reduce deterioration of the picture quality, it is necessary to adjust the resonance frequency of the optical deflector to a predetermined value.

Conventional examples mentioned above have the following problems in relation to adjustment of the resonance frequency to a predetermined value.

That is, in the structure shown in Japanese Laid-Open Patent Application No. 2002-40355, when a laser beam is projected to the mass loading member of the galvano mirror to remove the mass so as to adjust the inertia moment, a driving member including a planar coil provided to drive the oscillation plate may be damaged by the laser beam.

Furthermore, even if the moving coil type of Japanese Laid-Open Patent Application No. 2002-40355 is replaced by a moving magnet type, a coil has to be provided around the movable plate. Therefore, during the laser-beam processing, the driving member including the coil may be similarly damaged.

The present invention provides a method of manufacturing an oscillator device by which the mass of the oscillation plate can be adjusted precisely without damaging a peripheral portion including the driving member of the oscillation plate and by which an oscillator device can be manufactured at high precision. In another aspect, the present invention provides an optical deflector and/or an image forming apparatus by which at least one of the inconveniences described above can be removed or reduced.

In accordance with an aspect of the present invention, there is provided a method of manufacturing an oscillator device having a fixed member and an oscillation plate supported by the fixed member through a supporting member for oscillation around a torsion axis, the oscillation plate being driven at a resonance frequency around the torsion axis, said method comprising: a frequency regulating step based on an extension member for adjustment of a mass of the oscillation plate, for forming the extension member on the oscillation plate and for adjusting the mass of the oscillation plate by cutting a portion of the extension member with the irradiation of a laser beam; an oscillator assembling step for fixing the fixed member to a fixed base; and a driving member assembling step for fixing a driving member for driving the oscillation plate to the fixed base; wherein at least said driving member assembling step is carried out after said frequency regulating step based on the extension member is performed.

In one preferred form of this aspect of the present invention, the method further comprises, for adjustment of the mass of the oscillation plate, a frequency regulating step for forming a channel in a region of the oscillation plate, such that the mass of the oscillation plate is adjusted based on the formation of the channel.

At least said step of fixing the driving member may be carried out after said frequency regulating step based on the extension member and said frequency regulating step based on the channel are completed.

At least said step of fixing the driving member may be carried out after completion of said frequency regulating step based on the extension member and before completion of said frequency regulating step based on the channel.

At least said frequency regulating step based on the extension member may be carried out after completion of said oscillator assembling step and before completion of said driving member assembling step.

The oscillation plate may have at least two frequencies of natural oscillation modes around the torsion axis, based on a first oscillation plate and a second oscillation plate.

For adjustment of the resonance frequency of the oscillation plate, a frequency of a natural oscillation mode of the oscillation plate around the torsion axis may be detected, and based on a difference between the detected frequency and a predetermined resonance frequency, the amount of adjustment of the inertia moment of the oscillation plate may be determined.

At least one of a width of the channel, a depth of the channel and a number of the channel or channels may be determined based on the amount of adjustment of the inertia moment of the oscillation plate.

By irradiation of the laser beam, the channel may be formed in a direction orthogonal to the torsion axis to extend from one side to the other side of the oscillation plate or the extension member.

In accordance with another aspect of the present invention, there is provided an optical deflector, comprising: an oscillator device manufactured in accordance with an oscillator device manufacturing method as recited above; and an optical deflecting element formed on an oscillator of the oscillator device.

In accordance with a further aspect of the present invention, there is provided an optical instrument, comprising: a light source; one of a photosensitive member and an image display device; and an optical deflector as recited above; wherein light from said light source is deflected by said optical deflector, and at least a portion of the light is incident on said photosensitive member or image display device.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a diagram for explaining a frequency regulating step using a channel, in one preferred form of the present invention.

FIGS. 2A and 2B are diagrams for explaining a step of forming a channel in an oscillation plate for the inertia moment adjustment, in one preferred form of the present invention, wherein FIG. 2A is a diagram illustrating the structure in which a linear channel is formed in an oscillation plate, and FIG. 2B is a B-B sectional view of FIG. 2A.

FIG. 3 is a diagram for explaining a case wherein the mass of a particular portion of the oscillation plate is removed, in a comparative example.

FIG. 4 is a diagram for explaining an example of a method of forming a channel in an oscillation plate, in one preferred form of the present invention.

FIG. 5 is a diagram for explaining the adjustment of the frequency, based on the frequency regulating step using a channel and the frequency regulating step using an extension member, in one preferred form of the present invention.

FIG. 6 is a diagram for explaining a method of manufacturing an oscillator device which is comprised of a first oscillation plate and a second oscillation plate, in one preferred form of the present invention.

FIG. 7 is a diagram for explaining the locus of sinusoidal vibration and approximately sawtooth-wave oscillation, in one preferred form of the present invention.

FIG. 8 is a flow chart for explaining the manufacturing process according to a first embodiment of the present invention.

FIG. 9 is a top plan view of an oscillator device after completion of Step 8 in FIG. 8, for explaining an oscillator device manufactured in accordance with the manufacturing process of the first embodiment of the present invention.

FIG. 10 is an A-A′ sectional view of FIG. 9, for explaining an oscillator device manufactured in accordance with the manufacturing process of the first embodiment of the present invention.

FIG. 11 is a top plan view for explaining an oscillator device used in the manufacturing process of the first embodiment of the present invention.

FIG. 12 is a B-B′ sectional view of FIG. 11, for explaining an oscillator device used in the manufacturing process of the first embodiment of the present invention.

FIG. 13 is a flow chart for explaining a manufacturing process according to a second embodiment of the present invention.

FIG. 14 is a flow chart for explaining a manufacturing process according to a third embodiment of the present invention.

FIG. 15 is a top plan view of an oscillator device after completion of Step 8 in FIG. 14, for explaining an oscillator device manufactured in accordance with the manufacturing process of the third embodiment of the present invention.

FIG. 16 is a C-C′ sectional view of FIG. 15, for explaining an oscillator device manufactured in accordance with the manufacturing process of the third embodiment of the present invention.

FIG. 17 is a top plan view for explaining an oscillator device used in the manufacturing process of the third embodiment of the present invention.

FIG. 18A is a D-D′ sectional view of FIG. 17, for explaining an oscillator device used in the manufacturing process of the third embodiment of the present invention.

FIG. 18B is a diagram illustrating a structure having an oscillation plate.

FIG. 18C is a diagram illustrating a jig for driving the oscillation plate.

FIG. 19 is a diagram for explaining an image forming apparatus according to a fourth embodiment of the present invention.

FIG. 20 is a diagram for explaining a planar type galvano mirror of conventional example.

### BEST MODE FOR PRACTICING THE INVENTION

With the structure mentioned hereinbefore, the present invention enables manufacture of an oscillator device by which the mass of the oscillation plate can be adjusted precisely without damaging the periphery portion including a driving member of the oscillation plate. This is based on the following findings made by the inventors of the present invention.

Namely, the inventors have found that when the manufacture of an oscillator device in which an oscillation plate is driven around a torsion axis at a resonance frequency needs laser beam penetration machining for the frequency regulation, if the assembling step of the driving member is carried out after the frequency regulating step, the damage of the driving member by the machining laser can be avoided.

In the present invention, the frequency regulation is comprised of the following two frequency regulating step.

One is a frequency regulating step based on a channel, in which, in the adjustment of the mass of the oscillation plate, a channel is formed in a region of the oscillation plate and the mass of the oscillation plate is adjusted based on the formation of that channel.

The other is a frequency regulating step based on an extension member, in which, in the adjustment of the mass of the oscillation plate, an extension member which extends in a direction parallel to the torsion axis is formed in the oscillation plate as a unit with the oscillation plate, and the mass of the oscillation plate is adjusted by cutting a portion of the extension member.

The present invention uses a step of adjusting the frequency based on the laser beam processing which includes penetrating a portion to be processed, like the frequency regulating step based on the extension member.

Here, at least the driving member assembling step among these steps may be carried out after completion of the frequency regulating step based on the extension member. This ensures that the assembly of the oscillator device can be made without damaging the driving member by the processing laser.

A method of manufacturing an oscillator device in one preferred form of the present invention will be explained below.

First of all, an example wherein the regulation of the frequency of the oscillator device is carried out in accordance with the frequency regulating step based on the channel as described above, will be explained.

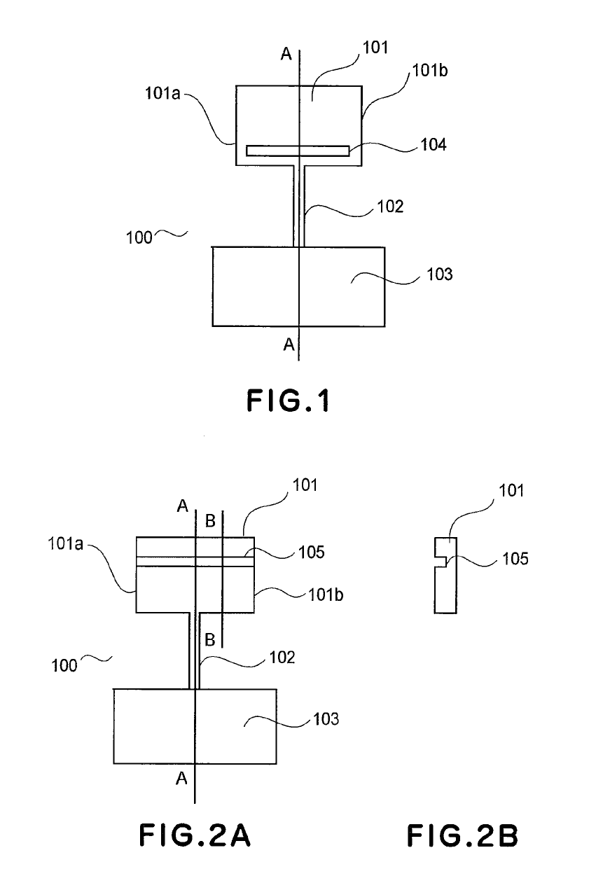

FIG. 1 is a diagram for explaining the frequency regulating step based on a channel, in this preferred form of the present invention.

Denoted in FIG. 1 at 100 is an oscillator device, and denoted at 101 is an oscillating plate. Denoted at 102 a resilient supporting member, and denoted at 103 is a fixed member. Denoted at 104 is a permanent magnet.

In the oscillator device of this preferred form of the present invention, the oscillation plate 101 is supported by the fixed member 103 through by the resilient supporting member 102.

The oscillation plate 101 has sides 101a and 101b which are parallel to the torsion axis A.

The resilient supporting member 102 resiliently supports the oscillation plate 101 for torsional oscillation around the torsion axis A.

The oscillator device 100 has a natural oscillation mode of torsional oscillation around the torsion axis A. The frequency thereof can be expressed by the following equation.

f=1/(2·π)·√(2·K/I) (1)

wherein K is the torsion spring constant of the resilient supporting member 102 around the torsion axis A, and I is the inertia moment of the oscillation plate 101 around the torsion axis A.

A permanent magnet 104 is mounted on the oscillation plate 101. The permanent magnet 104 is polarized in the longitudinal direction as viewed in the diagram. By means of a magnetic coil (not shown), an alternating current magnetic field is applied and a torque can be produced.

By setting the frequency of the alternating current magnetic field at around the frequency f of the natural oscillation mode, oscillation based on the resonance phenomenon can be provided.

In the manufacture of an oscillator device such as described above, the inertia moment may be adjusted in accordance with a method to be described below, by which the frequency of the natural oscillation mode can be adjusted very precisely.

First of all, the oscillator device 100 is driven and the frequency f of the natural oscillation mode is detected.

With regard to the method of detecting the frequency f, an example is that, while sweeping the frequency of the alternating magnetic field applied to the magnetic coil, the amplitude of oscillation of oscillator device 100 in the torsional direction is detected by using driving waveform detecting means, and the frequency of the alternating magnetic field with which the maximum amplitude is obtained is taken as the frequency f of the natural oscillation mode.

From the difference between the frequency of the natural oscillation mode measured using such measuring means and the adjustment target value, the necessary inertia moment adjustment amount is calculated based on the relationship of equation (1) mentioned above.

Based on the adjustment amount of the inertia moment of the oscillation plate calculated in the manner described above, at least one of the width of the channel, the depth of the channel and the number of the channel or channels is determined. Then, the channel with which the inertia moment can be adjusted is formed in the following manner, in a region of the oscillation plate.

FIGS. 2A and 2B are diagrams for explaining a step of forming a channel in the oscillation plate which channel enables the inertia moment adjustment. FIG. 2A is a diagram illustrating the structure in which a linear channel is formed in the oscillation plate, and FIG. 2B is a B-B section of FIG. 2A.

In this preferred form of the present invention, the channel is formed in a direction orthogonal to the torsion axis to extend from one side to the other side of the oscillation plate.

More specifically, as shown in FIGS. 2A and 2B, through the irradiation of a processing laser beam, a straight channel 105 is formed to extend from a side 101a to another side 101b which are parallel to the torsion axis A of the oscillation plate 101.

Particularly, where the oscillator device 100 is manufactured based on the semiconductor manufacturing process, since the shape thereof can be made extraordinarily precisely, e.g., at an order of ±1 μm or less, high precision adjustment of the inertia moment can be accomplished by processing the channel continuously from a side 101a to another side 101b.

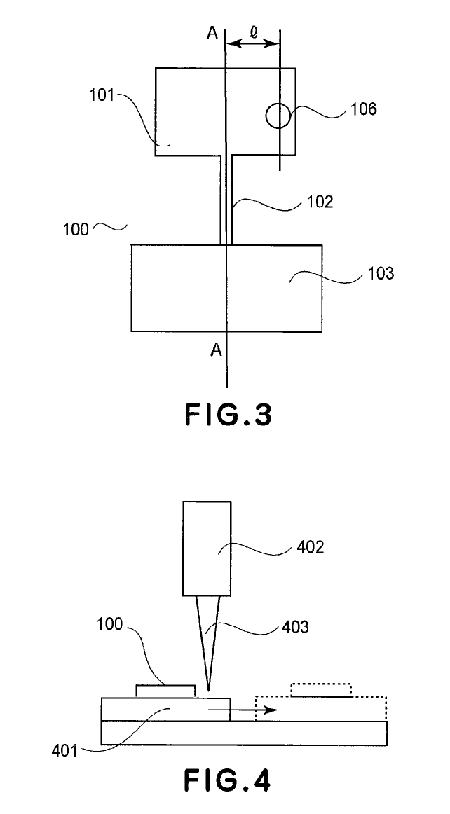

FIG. 3 shows a comparative example in which the mass of a predetermined portion 106 of the oscillation plate is removed.

The adjustment amount Iₜ of the inertia moment of the oscillation plate 101 around the torsion axis A can be expressed by:

Iₜ=m·l² (2)

where m is the mass removed, and l is the distance between the torsion axis A and the gravity center of the portion removed.

As shown by the equation (2), since the adjustment amount Iₜ of the inertia moment is proportional to the square of the distance l, in order to adjust the inertia moment precisely, it is necessary to adjust the processing point very accurately.

Namely, the precision of a polarizer for polarizing the processing laser light and the stage precision for moving the oscillator device must be controlled very accurately. This inevitably leads to expensiveness of the machining equipment and slow down of the processing speed.

Next, an example of a method of forming a channel in the oscillation plate 101, in this preferred form of the present invention will be explained. FIG. 4 is a diagram for explaining this method.

The oscillator device 100 is mounted on the stage 401. A laser source 402 is disposed so that a processing laser beam 403 therefrom is focused on the oscillation plate 101. As the oscillation plate 101 is moved by the stage 401 in the direction of an arrow, a channel can be formed continuously from a side 101a to the other side 101b of the oscillation plate 101.

The inertia moment by the processing is that the side 101a and the side 101b are parallel to the torsion axis A of the oscillation plate 101. Therefore, there is no influence of a positional error of the stage in a direction of the normal to the sheet of the drawing. Furthermore, since the oscillation plate 101 is processed from one side to the other side, there is no influence of a positional error of the stage 401 in the advancement direction the stage.

Hence, the adjustment accuracy of the inertia moment has sensitivity only to the accuracy of shape of the oscillation plate 101, and it does not depend on the positional accuracy of the stage 401.

As a result of this, use of a low-precision and high-speed driving stage is enabled, such that reduction of the cost of the device and enhancement of the processing speed are accomplished. Although in this example the movement of the processing position is made by use of a stage, similar advantageous results are attainable if the processing laser beam 403 is scanned by use of a polarizer or the like.

According to the frequency regulating process based on the channel described above, with the formation of a channel in the oscillation plate which channel enables adjustment of the inertia moment, the processing which can be independent from the positioning accuracy of the processing unit assures high-precision adjustment of the frequency of the natural oscillation mode.

Next, an example wherein the adjustment of the frequency of the oscillator device is made on the basis of the frequency regulating process based on a channel as described above as well as a frequency regulating process based on an extension member will be explained.

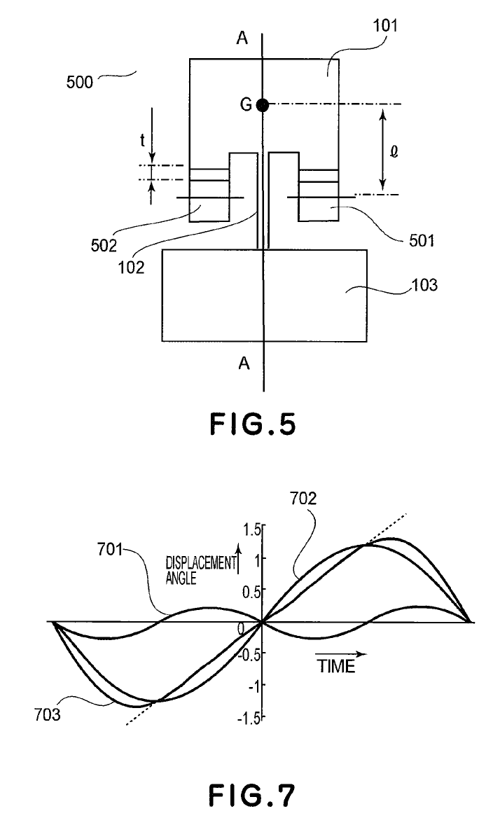

FIG. 5 is a diagram for explaining the adjustment of the frequency in this preferred form of the present invention, which is comprised of a frequency regulating step based on a channel and a frequency regulating step based on an extension member.

Since similar reference numerals are assigned in FIG. 5 to components corresponding to those of FIG. 1, duplicate description of similar components will be omitted here.

In FIG. 5, denoted at 500 is an oscillator device, and denoted at 501 and 502 are extension members.

In the oscillator device 500 of this preferred form of the present invention, the oscillation plate 101 has a thickness 300 μm, a length 1 mm in the direction of the torsion axis A, and a width of 3 mm. Furthermore, the oscillation plate 101 has extension members 501 and 502.

As shown in FIG. 5, these extension members 501 and 502 are formed as extensions at positions being symmetric with respect to the torsion axis A, the extensions being extending in the oscillation plate in the direction parallel to the torsion axis.

By cutting a portion of the extension, the mass of the oscillation plate can be adjusted.

Furthermore, these extensions are so configured that the channel mentioned hereinbefore can be formed on at least one of the front surface and the back surface of the extension member.

The oscillation plate 101, resilient supporting member 102 and fixed member 103 are formed by etching monocrystal silicon through dry etching.

The oscillator device 500 has a natural oscillation mode of torsional oscillation around the torsion axis A. The frequency f thereof can be expressed by equation (1) mentioned hereinbefore.

Since the spring constant K and the inertia moment I are variable with the manufacturing dispersion or environmental changes, there would be an error between the frequency f of a produced oscillator device and the predetermined target frequency.

In consideration of this, when an oscillator device is made, the inertia moment is adjusted and, based on this, the frequency of the natural oscillation mode can be adjusted very accurately.

First of all, the frequency of the natural oscillation mode is measured and, from the difference between the measured frequency and the adjustment target value, the required inertia moment adjustment amount is calculated using the relationship of equation (1) mentioned hereinbefore. Then, in accordance with the calculated inertia moment adjustment amount, the frequency of the oscillation plate is adjusted using the frequency regulating step based on the extension member and the frequency regulating step based on the channel.

Here, as an example, first, by using the frequency regulating step based on the extension member, the position where the extension member should be cut is controlled in accordance with the inertia moment adjustment amount.

Namely, if the adjustment amount is large, the cutting distance l in the drawing is shortened. If the adjustment amount is small, the cutting distance l is lengthened.

In this preferred form of the present invention, the cutting distance is determined with reference to the gravity center G of the oscillation plate. However, it may be determined taking an end portion or an alignment mark as a reference.

Furthermore, although cutting both of extension members which are disposed symmetrically with respect to the torsion axis A is desirable, only either one of the extension members may be cut.

By cutting the extension member or members, a larger amount of inertia moment can be adjusted as compared with a second step to be described below.

Then, using the frequency regulating step based on the channel, the width t of the linear channel to be continuously formed from one side to the other side of the extension member in accordance with the inertia moment adjustment amount is controlled.

More specifically, if the adjustment amount is large, the width t of the channel in the drawing is broadened, and if the adjustment amount is not large, the width t of the channel in the drawing is narrowed.

Although in this preferred form of the present invention the width of the channel is adjusted, the depth of the channel or, alternatively, the number of the channels (if plural channels are formed) may be adjusted.

By forming the channel in a protrusion-like shape precisely formed by dry etching, the inertia moment can be adjusted very accurately.

In the adjustment of the mass of the oscillation plate, in this preferred form of the present invention, at least the assembling step for fixing the driving member to the fixed base may be carried out after the processing step using processing laser, including the penetration of the portion to be processed, such as the frequency regulating step based on the extension member.

This effectively prevents damage of the driving member by the processing laser.

Although one preferred form of the present invention has been explained with reference to an example wherein a single oscillation plate is used, the present invention is not limited to this structure.

For example, the oscillation plate may be comprised of a first oscillation plate and a second oscillation plate, and thus the oscillator device may have at least two frequencies of natural oscillation mode around the torsion axis.

Next, an example of a manufacturing method of an oscillator device which is comprised of such first oscillation plate and second oscillation plate will be explained.

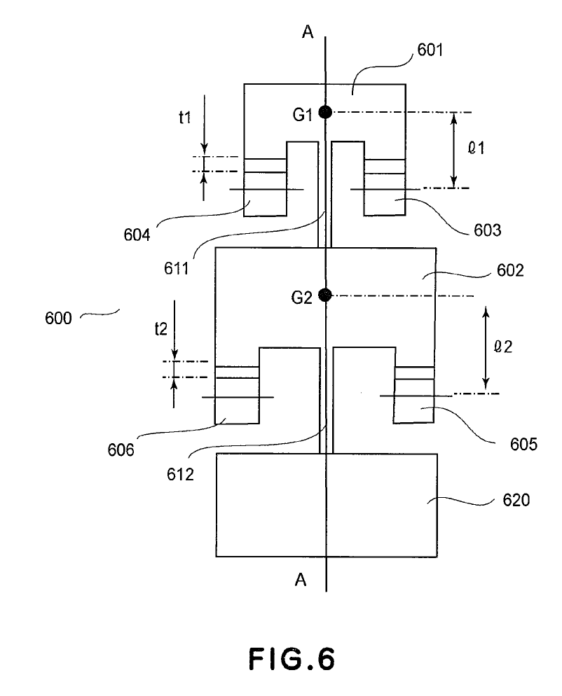

FIG. 6 is a diagram for explaining a method of manufacturing an oscillator device comprised of a first oscillation plate and a second oscillation plate, according to one preferred form of the present invention.

In FIG. 6, denoted at 601 is a first oscillation plate, and denoted at 602 is a second oscillation plate. Denoted at 611 is a first resilient supporting member, and denoted at 612 is a second resilient supporting member.

The oscillator device 600 of this preferred form of the present invention includes an oscillation plate which is comprised of the first and second oscillation plates, and it has a structure having at least two frequencies of natural oscillation mode around the torsion axis. More specifically, it comprises a first oscillation plate 601, a second oscillation plate 602, a first resilient supporting member 611, a second resilient supporting member 612 and a fixed member 620.

Here, the first oscillation plate 601 has a thickness of 300 μm, a length of 1 mm in the direction of the torsion axis A, and a width of 3 mm.

Furthermore, the second oscillation plate 602 has a thickness of 300 μm, a length of 2 mm in the direction of the torsion axis, and a width of 6 mm.

The oscillation plate has extension members 603, 604, 605 and 606. Theses extension members are connected to the oscillation plates 601 and 602 at symmetric positions as illustrated with respect to the torsion axis A. All the extension members are formed to extend in a direction parallel to the torsion axis A.

The first oscillation plate 601 and the second oscillation plate 602 are connected to each other through the first resilient supporting member 611, for torsional oscillation, and the second oscillation plate 602 is fixed to the fixed member 620 for torsional oscillation by the second resilient supporting member 612.

The oscillation plates, the resilient supporting members and the fixed member are formed by dry etching monocrystal silicon.

The oscillator device 600 has two frequencies f1 and f2 of eigenmode, around the torsion axis A. By applying a driving force including two eigenmodes, the oscillator device realizes torsional oscillation based on synthesizing two sinusoidal waves.

Particularly, when f1 and f2 are in a two-fold relationship, approximately sawtooth-wave oscillation 703 such as shown in FIG. 7 can be realized by adjusting the amplitudes of the two sinusoidal oscillations 701 and 702.

As compared with a sinusoidal wave, the approximately sawtooth-wave oscillation 703 enables that the substantially constant angular-speed region is widened, such that the available region relative to the whole area of the scanning deflection can be enlarged.

On the other hand, in order to obtain a predetermined combined waveform as described above, it is necessary to precisely adjust the frequencies f1 and f2 of the two eigenmodes of the oscillator device.

Generally, the frequencies f1 and f2 of two natural oscillation modes of an oscillation system including two oscillation plates and two resilient supporting members are presented by an equation (3) below.

$$f 1 = \sqrt{\frac{\begin{matrix}I 2 k 1 + I 1 k 2 + I 2 k 2 - \\ \sqrt{- 4 I 1 I 2 k 1 k 2 + {( I 1 k 2 + I 2 ( k 1 + k 2 ) )}^{2}}\end{matrix}}{8 I 1 I 2 {π}^{2}}} \\ f 2 = \sqrt{\frac{\begin{matrix}I 2 k 1 + I 1 k 2 + I 2 k 2 + \\ \sqrt{- 4 I 1 I 2 k 1 k 2 + {( I 1 k 2 + I 2 ( k 1 + k 2 ) )}^{2}}\end{matrix}}{8 I 1 I 2 {π}^{2}}} \qquad ( 3 )$$

Here, k1 and k2 are torsion spring constants of the first resilient supporting member 611 and the second resilient supporting member 612 around the torsion axis A, and I1 and I2 are the inertia moment of the first oscillation plate 601 and the second oscillation plate 602 around the torsion axis A.

Since the spring constant K and the inertia moment I are variable with the manufacturing dispersion or environmental changes, there would be an error between the frequency f of a produced oscillator device and the predetermined target frequency.

In consideration of this, when an oscillator device is made, the inertia moment is adjusted in accordance with a method to be described below and, based on this, the frequency of the natural oscillation mode can be adjusted very accurately.

First of all, the frequency of the natural oscillation mode is measured and, from the difference between the measured frequency and the adjustment target value, the required inertia moment adjustment amount of each of the first oscillation plate 601 and the second oscillation plate 602 is calculated using the relationship of equation (3) mentioned hereinbefore.

Then, in accordance with the calculated inertia moment adjustment amount, the frequencies f1 and f2 of the oscillator device are adjusted by adjusting the inertia moments of the first and second oscillation plates 601 and 602, respectively, using the frequency regulating step based on the extension member and the frequency regulating step based on the channel.

Here, as an example, first, by using the frequency regulating step based on the extension member, the position where the extension member should be cut is controlled in accordance with the inertia moment adjustment amount.

Namely, if the adjustment amount is large, the cutting distance l in the drawing is shortened. If the adjustment amount is small, the cutting distance l is lengthened.

In this preferred form of the present invention, the cutting distance is determined with reference to the gravity center G of the oscillation plate. However, it may be determined taking an end portion or an alignment mark as a reference.

Furthermore, although cutting both of extension members which are disposed symmetrically with respect to the torsion axis A is desirable, only either one of the extension members may be cut.

By cutting the extension member or members, a larger amount of inertia moment can be adjusted as compared with a second step to be described below.

Then, using the frequency regulating step based on the channel, the width t of the linear channel to be continuously formed from one side to the other side of the extension member in accordance with the inertia moment adjustment amount is controlled.

More specifically, if the adjustment amount is large, the width t of the channel in the drawing is broadened, and if the adjustment amount is not large, the width t of the channel in the drawing is narrowed.

Although in this preferred form of the present invention the width of the channel is adjusted, the depth of the channel or, alternatively, the number of the channels (if plural channels are formed) may be adjusted.

By forming the channel in a protrusion-like shape precisely formed by dry etching, the inertia moment can be adjusted very accurately.

In the adjustment of the mass of the oscillation plate, in this preferred form of the present invention, at least the assembling step for fixing the driving member to the fixed base may be carried out after the processing step using a processing laser, including the penetration of the portion to be processed, such as the frequency regulating step based on the extension member.

This effectively prevents damage of the driving member by the processing laser.

Furthermore, a reflection surface as an optical deflecting element may be disposed on an oscillation plate of an oscillator device and, in that occasion, the oscillator device can be used as an optical deflector. Furthermore, an image forming apparatus can be provided with the structure that an optical deflector such as described above, a light source and a photosensitive member are included and light from the light source is deflected by the optical deflector so that at least a portion of the light is incident on the photosensitive member.

Now, several preferred embodiments of the present invention will be explained.

### Embodiment 1

A first embodiment will be described with reference to an example of a method of manufacturing an oscillator device wherein, in the adjustment of the mass of an oscillation plate, to avoid damage of a driving member, a frequency regulating step based on an extension member for cutting a portion of the extension member using a laser beam is finished and, subsequently, a frequency regulating step based on a channel is carried out; and after that, at least a driving member assembling step for fixing the driving member is performed.

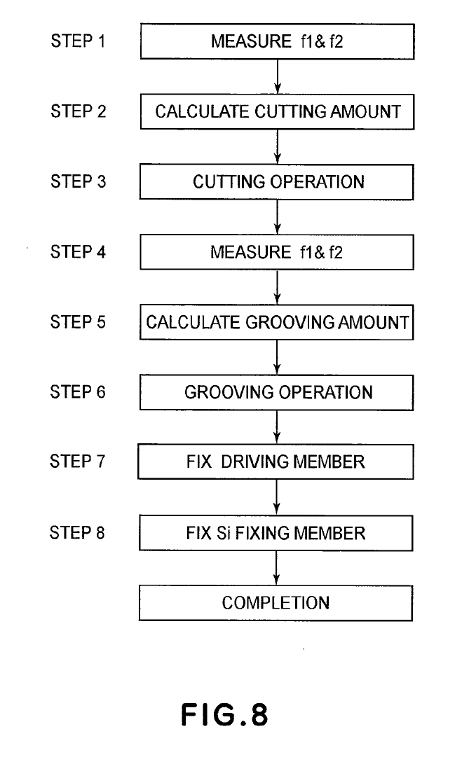

FIG. 8 is a flow chart for explaining the manufacturing process in the present embodiment.

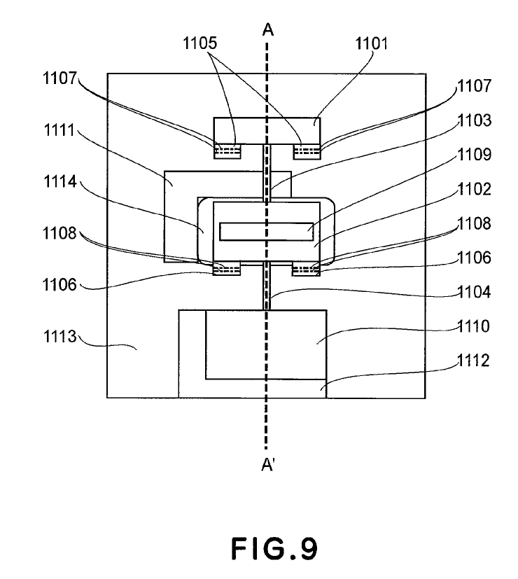

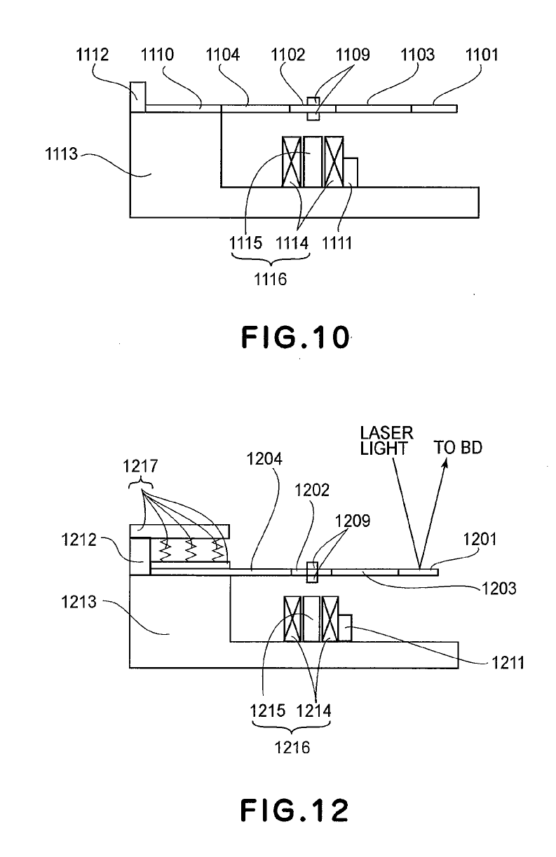

FIG. 9 and FIG. 10 are diagrams for explaining an oscillator device manufactured through the manufacturing process of the present embodiment. FIG. 9 is a top plan view of the oscillator device after the completion of the process up to Step 8 in FIG. 8, and FIG. 10 is A-A′ section of FIG. 9.

In FIG. 9 and FIG. 10, denoted at 1101 is a first oscillation plate, and denoted at 1102 is a second oscillation plate. Denoted at 1103 is a first resilient supporting member, and denoted at 1104 is a second resilient supporting member.

Denoted at 1107 and 1108 are channels, and denoted at 1105 and 1106 are extension members. The structure illustrated there is that: through the process up to Step 8 in FIG. 8, these extension members and channels have been processed and the mass of the oscillation plate has been adjusted thereby.

Denoted at 1109 is a hard magnetic material, and denoted at 1110 is a Si fixed member. Denoted at 1111 a driving-member abutment member, and denoted at 1112 is a Si fixed-member abutment member. Denoted at 1113 is a fixed base.

The oscillator device of the present embodiment has a structure that the oscillation plate is comprised of a first oscillation plate 1101 and a second oscillation plate 1102, and it has at least two frequencies of natural oscillation modes around the torsion axis. More specifically, it comprises a first oscillation plate 1101, a second oscillation plate 1102, a first resilient supporting member 1103, a second resilient supporting member 1104, and a Si fixed member 1110. The first oscillation plate 1101 has a reflection surface (not shown) which is formed on a surface thereof remote from the driving member 1116.

The driving member 1116 is comprised of an electric coil 1114 and a core 1115. It is positioned by the driving-member abutment member 1111, and it is fixed to the fixed base 1113 by an adhesive, at the bottom face of the driving member 1116.

The Si fixed member 1110 is positioned by means of the Si fixed-member abutment member 1112, and it is fixed to the fixed base 1113 by an adhesive.

Now, referring to FIG. 8, the manufacturing process of the present embodiment will be explained.

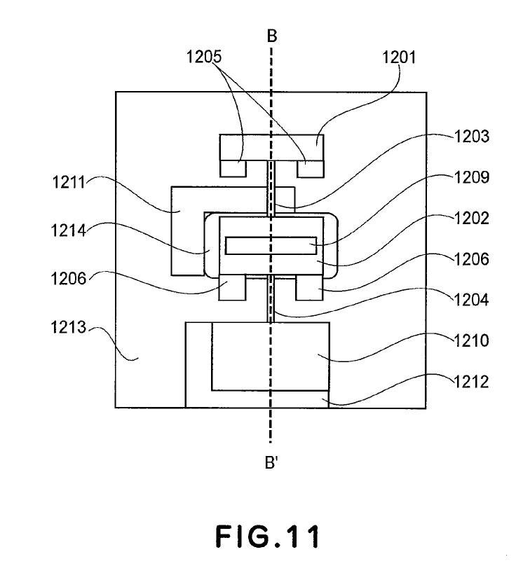

At step 1, using the oscillator device for manufacture shown in FIG. 11 and FIG. 12, the first oscillation plate 1201 and the second oscillation plate 1202 of the oscillator device are oscillated.

Then, a laser beam emitted from a laser (not shown) is reflected by the reflection surface (not shown) formed on the first oscillation plate 1201. The reflected laser beam is received by two beam detectors (not shown), whereby the scan time interval is measured.

Based on this, the frequencies f1 and f2 of the natural oscillation modes of the first oscillation plate 1201 and the second oscillation plate 1202 are measured.

Here, the oscillator device for manufacture shown in FIG. 11 and FIG. 12 will be explained.

FIG. 11 is a top plan view of an oscillator device to be used in the manufacturing process of the present embodiment, and FIG. 12 is a B-B′ section of FIG. 11.

In FIG. 11 and FIG. 12, denoted at 1201 is a first oscillation plate, and denoted at 1202 is a second oscillation plate. Denoted at 1203 is a first resilient supporting member, and denoted at 1204 is a second resilient supporting member. Denoted at 1205 and 1206 are extension members. Denoted at 1209 is a hard magnetic material, and denoted at 1210 is a Si fixed member. Denoted at 1211 is a driving-member abutment member, and denoted at 1212 is a Si fixed-member abutment member. Denoted at 1216 is a driving member, and denoted at 1217 is a spring fixing member.

Here, the fixed board 1213, driving member 1216, Si fixed-member abutment member 1212 and spring fixing member 1217 of the oscillator device for manufacture as shown in FIG. 11 and FIG. 12 are configured to drive the oscillation plates 1201 and 1202 in the manufacturing process.

In the present embodiment, the first oscillation plate 1201 has a reflection surface (not shown) which is formed on the surface thereof remote from the driving member 1216. The driving member 1216 is comprised of an electric coil 1214 and a core 1215, and these are fixed to the fixed base 1213 by an adhesive, respectively.

The hard magnetic material 1209 is fixed to the second oscillation plate 1202 by an adhesive.

The Si fixed member 1210 is fixed to the fixed base 1213 through the spring fixing member 1217. Since the Si fixed member 1210 is fixed by using a spring fixing member 1217 as described above, the disassembly is easy and it can be fixed with few working hours.

Here, the Si fixed member 1210 may be sandwiched by metal plates or resin plates and it may be fixed by screws. Furthermore, the driving member 1216 of the oscillator device for manufacture may be disposed away from the oscillation plates 1201 and 1202 to avoid irradiation with the laser beam when the extension members 1205 and 1206 are cut by the laser beam. In that occasion, since the driving member 1216 is more separated from the hard magnetic material 1209 than the driving member 1116 of the finished oscillator device is, a larger electric current can be applied to the driving member 1216.

At step 2, from the difference between the measured frequency f1 (f2) and the target frequency and using the equation (3) mentioned above, the inertia moment adjustment amount required for the first oscillation plate 1201 and the second oscillation plate 1202, respectively, is calculated.

Subsequently, at step 3, the extension members 1205 and 1206 are cut in accordance with the calculated inertia moment adjustment amount.

Then, at step 4, like step 1, the frequencies f1 and f2 of natural oscillation modes of the first oscillation plate 1201 with its extension member 1205 having been cut by the laser beam (hereinafter, “first oscillation plate 1201 after the cutting”) and the second oscillation plate 1202 with its extension members 1206 having been cut (hereinafter, “second oscillation plate 1202 after the cutting”) are measured.

Subsequently, at step 5, from the difference between the measured frequency f1 (f2) and the target frequency and using the equation (3) mentioned above, the inertia moment adjustment amount required for the first oscillation plate 1201 after the cutting and the second oscillation plate 1202 after the cutting, respectively, is calculated.

After this, at step 6, straight channels 1107 and 1108 are formed continuously from one side to the other side of the extensions 1025 and 1206, in accordance with the calculated inertia moment adjustment amount.

It should be noted that the step 5 and step 6 may be omitted if f1 and f2 can be matched to the target frequencies by the cutting operation of the extension members at step 3. Whether or not f1 and f2 are matched with the target frequencies can be checked at step 4.

Subsequently, at step 7, the driving member 1116 is positioned by using the driving-member abutment member 1111, and then the driving member 1116 is fixed to the fixed base 1113 by an adhesive.

Thereafter, at step 8, the Si fixed member 1210 having been fixed by the spring fixing member 1217 is disengaged from the fixed base 1213. Then, the Si fixed member is positioned by using the Si fixed-member abutment member 1112, and the Si fixed member 1110 is fixed to the fixed base 1113 by an adhesive. In this manner, the oscillator assembling process is carried out.

After the frequency is adjusted based on the processing using a laser beam for processing including the penetration through a member to be processed, such as the cutting of the extension members 1205 and 1206, the driving member 1116 is fixed to the fixed base 1113.

This procedure enables assembling of the oscillator device without damaging the driving member 1116 by the processing laser beam.

Furthermore, in the oscillator assembling process, the Si fixed member 1110 is fixed to the fixed base 1113 after the frequency regulation.

This ensures that the surface of the first oscillation plate 1101 which is on the opposite side of its reflection surface can be irradiated with the processing laser beam. Thus, degradation of the reflectance due to adhesion of processing dust particles to the reflection surface can be effectively prevented.

Here, in the structure shown in FIG. 9 and FIG. 10, the Si fixed member 1110 is fixed to the fixed base 1113 by an adhesive.

On the other hand, in the structure shown in FIG. 11 and FIG. 12, the Si fixed member 1110 is fixed to the fixed base 1113 by a spring fixing member 1117.

Due to the difference in the manner of fixing as described above, there occurs a difference in the fixing strength. Thus, the frequencies f1 and f2 of two eigenmodes may vary with the fixing strength.

In that occasion, the target frequencies of f1 and f2 may be set while taking into account the deviation of f1 and f2 due to the fixing strength to the Si fixed members 1113 and 1213.

### Embodiment 2

A second embodiment will be described with reference to an example of a method of manufacturing an oscillator device wherein, in the adjustment of the mass of an oscillation plate, to avoid damage of a driving member, after completion of a frequency regulating step based on an extension member for cutting a portion of the extension member using a laser beam and before completion of a frequency regulating step based on a channel, a driving member assembling step for fixing a driving member to a fixed base and an oscillator assembling step for fixing an oscillation plate to the fixed base are carried out.

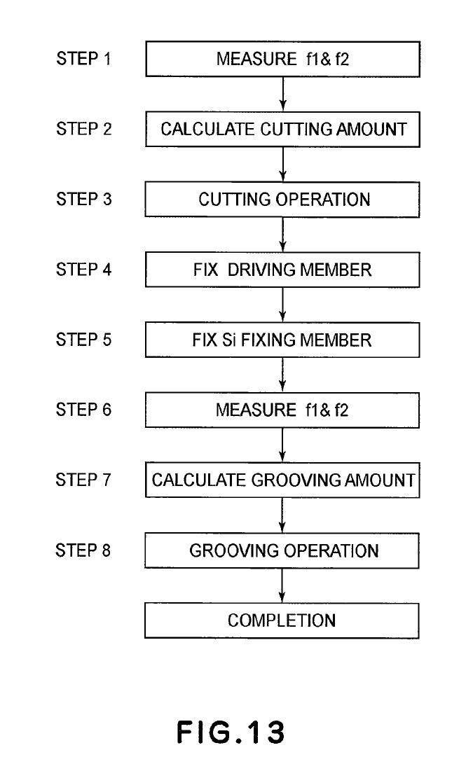

FIG. 13 is a flow chart for explaining the manufacturing process in the present embodiment.

With the manufacturing process of the present embodiment, an oscillator device like that of the first embodiment described hereinbefore is produced.

Thus, the structure of the oscillator device after completion of the procedure up to step 8 in FIG. 13 is the same as that shown in FIG. 9 and FIG. 10 of the first embodiment.

Next, referring to FIG. 13, the manufacturing process of the present embodiment will be explained.

At step 1, like step 1 (FIG. 8) of the first embodiment, the first oscillation plate 1201 and the second oscillation plate are driven using the oscillator device for manufacture, and the frequencies f1 and f2 of natural oscillation mode of them are measured.

Then, at step 2, from the difference between the measured frequency f1 (f2) and the target frequency and using the equation (3) mentioned above, the inertia moment adjustment amount required for the first oscillation plate and the second oscillation plate, respectively, is calculated.

Subsequently, at step 3, the extension members 1205 and 1206 are cut in accordance with the calculated inertia moment adjustment amount.

Then, at step 4, the driving member 1116 is positioned by using the driving-member abutment member 1111, and then the driving member 1116 is fixed to the fixed base 1113 by an adhesive.

After this, at step 5, the Si fixed member 1110 is positioned by using the Si fixed-member abutment member 1112, and the Si fixed member 1110 is fixed to the fixed base 1113 by an adhesive.

Subsequently, at step 6, like step 1, the frequencies f1 and f2 of natural oscillation modes of the first oscillation plate 1201 after the cutting and the second oscillation plate 1202 after the cutting are measured.

Then, at step 7, from the difference between the measured frequency f1 (f2) and the target frequency and using the relationship of equation (3) mentioned above, the inertia moment adjustment amount required for the first oscillation plate 1101 after the cutting and the second oscillation plate 1102 after the cutting, respectively, is calculated.

Subsequently, at step 8, straight channels 1107 and 1108 are formed continuously from one side to the other side of the extensions 1105 and 1106, in accordance with the calculated inertia moment adjustment amount.

After the frequency is adjusted based on the processing using a laser beam for processing including the penetration through a member to be processed, such as the cutting of the extension members 1205 and 1206, the driving member 1116 and the Si fixed member 110 are fixed to the fixed base 1113.

This procedure enables assembling of the oscillator device without damaging the driving member 1116 by the processing laser beam.

Furthermore, in this embodiment, after the Si fixed member 1110 is fixed to the fixed base 1113, fine tuning by the inertia moment adjustment based on the formation of the channels 1107 and 1108 is carried out. With this arrangement, the frequencies can be assuredly regulated to the target frequencies of f1 and f2 without the necessity of taking into account the deviation of the target frequencies of f1 and f2, as in the first embodiment.

Furthermore, in the present embodiment, the processing step for processing the channel is carried out after the driving member 1116 and Si fixed member 1110 are fixed to the fixed base 1113.

In this occasion, even if a processing laser beam is used in processing step of the channel, since it does not include penetration of a material by the processing laser beam, the oscillator device can be assembled without damaging the driving member 1116 by the processing laser beam.

### Embodiment 3

A third embodiment will be described with reference to an example of a method of manufacturing an oscillator device wherein, after completion of a step of fixing a Si fixed portion to a fixed base and before completion of a step of fixing a driving member to the fixed base, a step of cutting a portion of an extension member using a laser beam and a step of forming a channel are carried out.

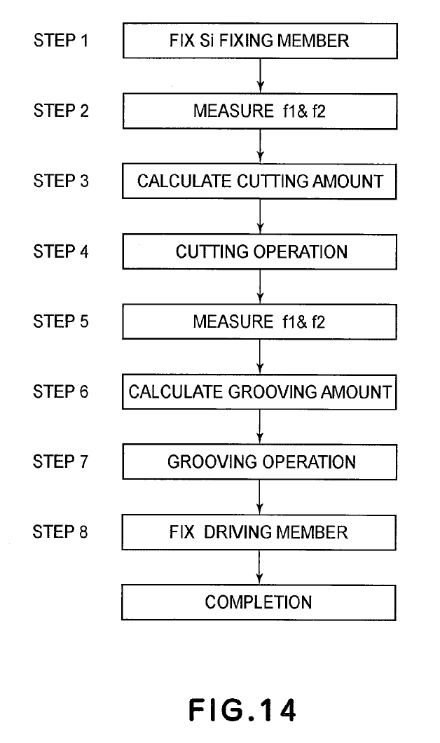

FIG. 14 is a flow chart for explaining the manufacturing process in the present embodiment.

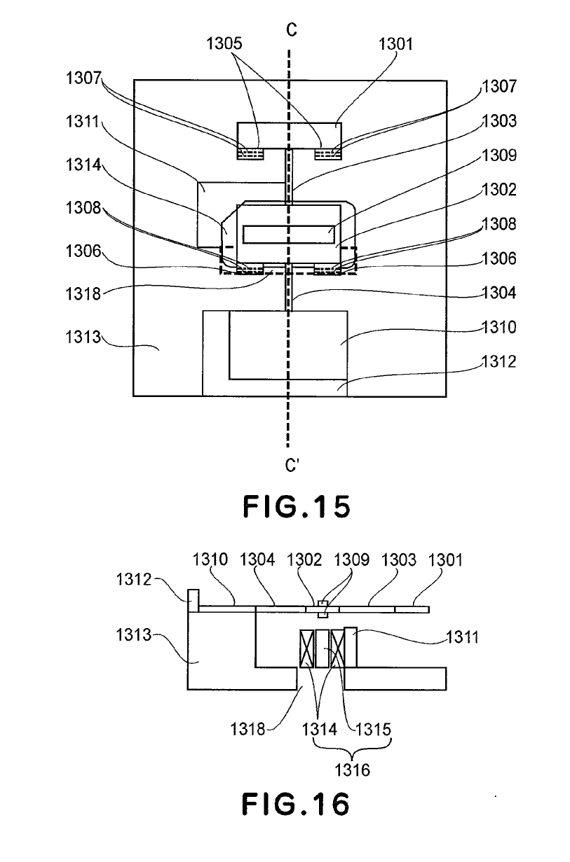

FIG. 15 and FIG. 16 are diagrams for explaining an oscillator device manufactured through the manufacturing process of the present embodiment. FIG. 15 is a top plan view of the oscillator device after the completion of the process up to Step 8 in FIG. 14, and FIG. 16 is a C-C′ section of FIG. 15.

In FIG. 15 and FIG. 16, denoted at 1301 is a first oscillation plate, and denoted at 1302 is a second oscillation plate. Denoted at 1303 is a first resilient supporting member, and denoted at 1304 is a second resilient supporting member.

Denoted at 1307 and 1308 are channels, and denoted at 1305 and 1306 are extension members. The structure illustrated there is that: through the process up to Step 8 in FIG. 14, these extension members and channels have been processed and the mass of the oscillation plate has been adjusted thereby.

Denoted at 1309 is a hard magnetic material, and denoted at 1310 is a Si fixed member. Denoted at 1311 a driving-member abutment member, and denoted at 1312 is a Si fixed-member abutment member. Denoted at 1313 is a fixed base.

The oscillator device of the present embodiment has a structure that the oscillation plate is comprised of a first oscillation plate 1301 and a second oscillation plate 1302, and it has at least two frequencies of natural oscillation modes around the torsion axis. More specifically, it comprises a first oscillation plate 1301, a second oscillation plate 1302, a first resilient supporting member 1303, a second resilient supporting member 1304, and a Si fixed member 1310. The first oscillation plate 1301 has a reflection surface (not shown) which is formed on a surface thereof remote from the driving member 1316.

The driving member 1316 is comprised of an electric coil 1314 and a core 1315. It is positioned by the driving-member abutment member 1311, and it is fixed to the fixed base 1313 by an adhesive. The Si fixed member 1310 is positioned by means of the Si fixed-member abutment member 1312, and it is fixed to the fixed base 1313 by an adhesive.

Now, referring to FIG. 14, the manufacturing process of the present embodiment will be explained.

At step 1, the Si fixed member 1310 is positioned by the Si fixed-member abutment member 1312 and it is fixed to the fixed base 1313 by an adhesive.

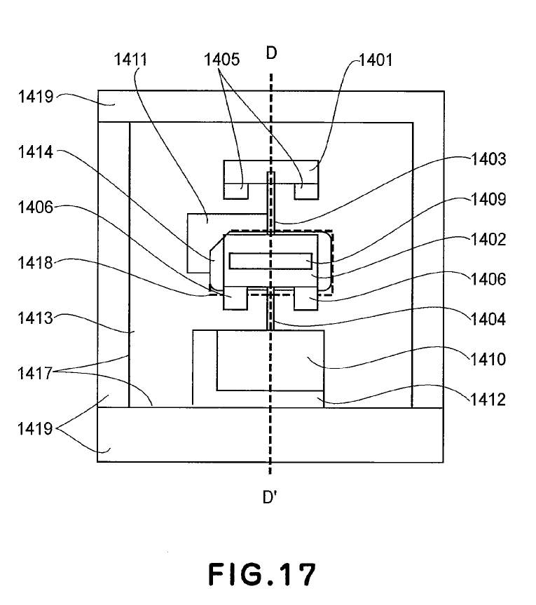

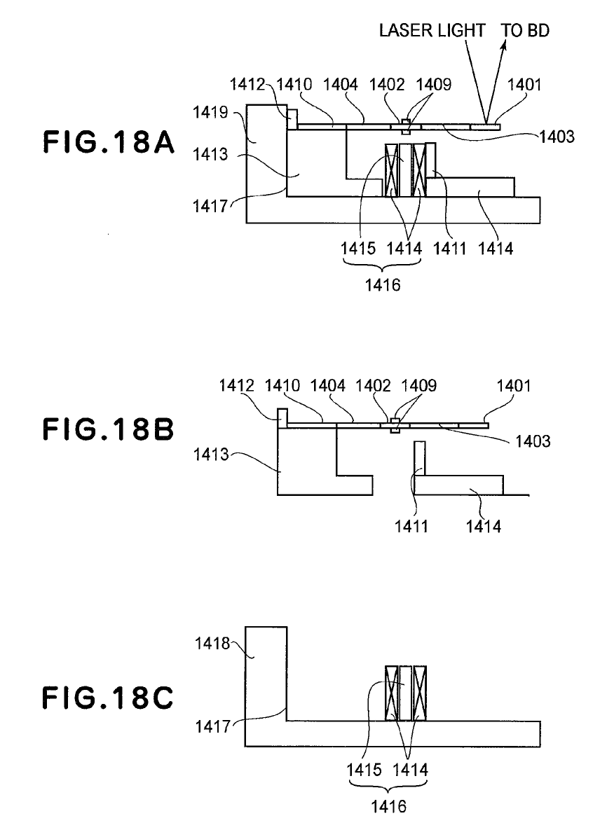

Subsequently, at step 2, using the oscillator device for manufacture shown in FIG. 17 and FIG. 18, the first oscillation plate 1401 and the second oscillation plate 1402 of the oscillator device are oscillated.

Then, a laser beam emitted from a laser (not shown) is reflected by the reflection surface (not shown) formed on the first oscillation plate 1401. The reflected laser beam is received by two beam detectors (not shown), whereby the scan time interval is measured.

Based on this, the frequencies f1 and f2 of the natural oscillation modes of the first oscillation plate 1401 and the second oscillation plate 1402 are measured.

Here, the oscillator device for manufacture shown in FIG. 17 and FIG. 18 will be explained.

FIG. 17 is a top plan view of an oscillator device to be used in the manufacturing process of the present embodiment, and FIG. 18A is a B-B′ section of FIG. 17.

In FIG. 17 and FIG. 18A, denoted at 1401 is a first oscillation plate, and denoted at 1402 is a second oscillation plate. Denoted at 1403 is a first resilient supporting member, and denoted at 1404 is a second resilient supporting member. Denoted at 1405 and 1406 are extension members.

Denoted at 1409 is a hard magnetic material, and denoted at 1410 is a Si fixed member. Denoted at 1411 is a driving-member abutment member, and denoted at 1412 is a Si fixed-member abutment member. Denoted at 1413 is a fixed base, and denoted at 1416 is a driving member. Denoted at 1418 is a through-hole, and denoted at 1419 is a fixed-base fixing member.

In the present embodiment, the first oscillation plate 1401 has a reflection surface (not shown) which is formed on the surface thereof remote from the driving member 1416.

The hard magnetic material 1409 is fixed to the second oscillation plate 1402 by an adhesive.

The Si fixed member 1410 is positioned by the Si fixed-member abutment member 1412, and it is fixed by an adhesive.

The driving member 1416 is comprised of an electric coil 1414 and a core 1415. It is fixed to the fixed-base fixing member 1419 by an adhesive.

In this embodiment, as shown in FIG. 18C, the driving member 1416 and the fixed-base fixing member 1419 function as a jig for driving the oscillation plates 1401 and 1402. The structure having the fixed base 1413 of FIG. 18B is disposed while being engaged against the fixing-base abutment surface 1417 of the fixed-base fixing member 1419 of FIG. 18C. When the fixed base 1413 and the fixed-base fixing member 1419 are fixed, the driving member 1416 penetrates through the through-hole 1418, and it is disposed at such position providing a magnetic function with the hard magnetic material 1409. It should be noted that, in this embodiment, the driving member 1416 of the oscillator device for manufacture may be disposed away from the oscillation plates 1401 and 1402 to avoid irradiation with the laser beam when the extension members 1405 and 1406 are cut by the laser beam. In that occasion, since the driving member 1416 is more separated from the hard magnetic material 1409 than the driving member 1416 of the finished oscillator device is, a larger electric current can be applied to the driving member 1416.

At step 3, from the difference between the measured frequency f1 (f2) and the target frequency and using the equation (3) mentioned above, the inertia moment adjustment amount required for the first oscillation plate 1401 and the second oscillation plate 1402, respectively, is calculated.

Subsequently, at step 4, the extension members 1405 and 1406 are cut in accordance with the calculated inertia moment adjustment amount.

Then, at step 5, like step 1, the frequencies f1 and f2 of natural oscillation modes of the first oscillation plate 1401 with its extension member 1405 having been cut by the laser beam (hereinafter, “first oscillation plate 1401 after the cutting”) and the second oscillation plate 1402 with its extension members 1406 having been cut (hereinafter, “second oscillation plate 1402 after the cutting”) are measured.

Subsequently, at step 6, from the difference between the measured frequency f1 (f2) and the target frequency and using the equation (3) mentioned above, the inertia moment adjustment amount required for the first oscillation plate 1401 after the cutting and the second oscillation plate 1402 after the cutting, respectively, is calculated.

After this, at step 7, straight channels 1307 and 1308 are formed continuously from one side to the other side of the extensions 1425 and 1406, in accordance with the calculated inertia moment adjustment amount.

It should be noted that the step 6 and step 7 may be omitted if f1 and f2 can be matched to the target frequencies by the cutting operation of the extension members at step 4. Whether or not f1 and f2 are matched with the target frequencies can be checked at step 5.

Subsequently, at step 8, the fixed base 1413 is disengaged from the fixed-base fixing member 1419. Then, the driving member 1316 goes through the through-hole 1318 and is positioned by the driving-member abutment member 1311, and it is fixed by an adhesive.

After the frequency is adjusted based on the processing using a laser beam for processing including the penetration through a member to be processed, such as the cutting of the extension members 1405 and 1406, the driving member is fixed to the fixed base.

This procedure enables assembling of the oscillator device without damaging the driving member by the processing laser beam.

Furthermore, in the present embodiment, the inertia moment adjustment is carried out using a processing laser beam after the Si fixed member is fixed to a fixed base. This assures that the frequencies are exactly adjusted to target frequencies of f1 and f2 without the necessity of taking into account the deviation of the target frequencies of f1 and f2 due to the fixing method, as in the first embodiment.

### Embodiment 4

A fourth embodiment will be described with reference to a structural example of an optical instrument using an optical deflector which is comprised of an oscillator device according to the present invention.

Here, an image forming apparatus is shown as an optical instrument.

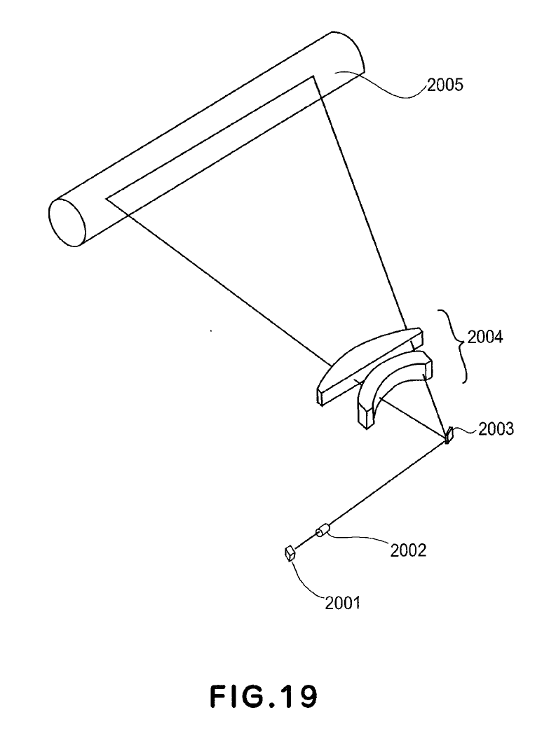

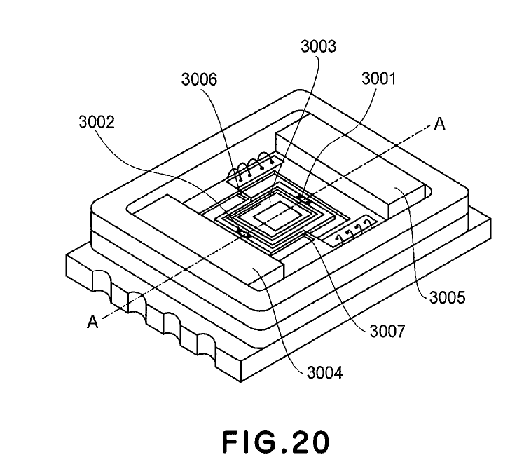

FIG. 19 is a schematic and perspective diagram for explaining the structural example of an optical instrument using an optical deflector which is comprised of an oscillator device according to the present embodiment.

In FIG. 19, denoted at 2001 is a laser source. Denoted at 2002 is a lens or lens group, and denoted at 2004 is a writing lens or lens group. Denoted at 2005 is a photosensitive member of drum shape.

The image forming apparatus of the present embodiment includes a light source, a photosensitive member and an optical deflector which has an optical deflecting element disposed on an oscillator and is comprised of an oscillator device of the present invention.

Light from the light source is deflected by the optical deflector, and at least a portion of the light is incident on the photosensitive member.

More specifically, as shown in FIG. 19, by means of the optical scanning system (oscillator device) 2003 which is comprised of an oscillator device according to any one of the preceding embodiment, the input light is scanned one-dimensionally.

Then, through the writing lens 2004, the scanning laser beam forms an image upon the photosensitive member 2005.

The photosensitive member 2005 is being uniformly charged by a charging device (not shown). When the photosensitive member surface is scanned with light, an electrostatic latent image is formed on the portion scanned by the light.

Subsequently, a toner image is formed on the imagewise portion of the electrostatic latent image, by means of a developing device (not shown). The toner image is then transferred to and fixed on a paper sheet (not shown), whereby an image is produced on the paper sheet.

Here, by means of the optical scanning system (oscillator device) 2003 which is comprised of an oscillator device according to any one of the preceding embodiments, the angular speed of the deflective scan of the light can be made approximately constant in a predetermined range.

Although in the foregoing description the invention has been explained with reference to examples of image forming apparatus as an optical instrument, the present invention is not limited to such structure.

For example, it may include a light source, an image display member and an optical deflector which is comprised of an oscillator device of the present invention, and a projection display device may be constituted thereby, arranging so that light from the light source is deflected by the optical deflector and is incident on the image display member.

Thus, in accordance with the oscillator device of the present invention, an oscillator device suitably applicable to optical instruments including a projection display device for projecting an image based on scanning deflection of light and an image forming apparatus such as a laser beam printer, digital copying machine or the like, having an electrophotographic process, can be accomplished.

While the invention has been described with reference to the structures disclosed herein, it is not confined to the details set forth and this application is intended to cover such modifications or changes as may come within the purposes of the improvements or the scope of the following claims.

1. A method of manufacturing an oscillator device having a fixed member and an oscillation plate supported by the fixed member through a supporting member for oscillation around a torsion axis, the oscillation plate being driven at a resonance frequency around the torsion axis, said method comprising:
a frequency regulating step based on an extension member for adjustment of a mass of the oscillation plate, for forming the extension member on the oscillation plate and for adjusting the mass of the oscillation plate by cutting a portion of the extension member with the irradiation of a laser beam;
an oscillator assembling step for fixing the fixed member to a fixed base; and
a driving member assembling step for fixing a driving member for driving the oscillation plate to the fixed base;
wherein at least said driving member assembling step is carried out after said frequency regulating step based on the extension member is performed.

2. A method according to claim 1, further comprising, for adjustment of the mass of the oscillation plate, a frequency regulating step for forming a channel in a region of the oscillation plate, such that the mass of the oscillation plate is adjusted based on the formation of the channel.

3. A method according to claim 2, wherein at least said step of fixing the driving member is carried out after said frequency regulating step based on the extension member and said frequency regulating step based on the channel are completed.

4. A method according to claim 2, wherein at least said step of fixing the driving member is carried out after completion of said frequency regulating step based on the extension member and before completion of said frequency regulating step based on the channel.

5. A method according to claim 1, wherein at least said frequency regulating step based on the extension member is carried out after completion of said oscillator assembling step and before completion of said driving member assembling step.

6. A method according to claim 1, wherein the oscillation plate has at least two frequencies of natural oscillation modes around the torsion axis, based on a first oscillation plate and a second oscillation plate.

7. A method according to claim 1, wherein, for adjustment of the resonance frequency of the oscillation plate, a frequency of a natural oscillation mode of the oscillation plate around the torsion axis is detected, and based on a difference between the detected frequency and a predetermined resonance frequency, the amount of adjustment of the inertia moment of the oscillation plate is determined.

8. A method according to claim 7, wherein at least one of a width of the channel, a depth of the channel and a number of the channel or channels is determined based on the amount of adjustment of the inertia moment of the oscillation plate.

9. A method according to claim 1, wherein, by irradiation of the laser beam, the channel is formed in a direction orthogonal to the torsion axis to extend from one side to the other side of the oscillation plate or the extension member.

10. An optical deflector, comprising:
an oscillator device manufactured in accordance with an oscillator device manufacturing method as recited in claim 1; and
an optical deflecting element formed on an oscillator of the oscillator device.

11. An optical instrument, comprising:
a light source;
one of a photosensitive member and an image display device; and
an optical deflector as recited in claim 10;
wherein light from said light source is deflected by said optical deflector, and at least a portion of the light is incident on said photosensitive member or image display device.
